(19) United States
(12) Patent Application Publication
(10) Pub. No.: US 2012/0131781 A1
(43) Pub. Date: May 31, 2012

(54) Saw blade reconditioning method

(76) Inventor: DARREN WALTON, San Rafael, CA (US)

(21) Appl. No.: 12/927,831

(22) Filed: Nov. 26, 2010

(51) Int. Cl. B23P 6/00

(52) U.S. Cl. 29/402.16

(57) ABSTRACT

A saw blade reconditioning method with a band saw blade member made from a portion of band saw blade material, a standard oscillating power tool blade shank having the serrated toothed blade portion removed and a butt welding fixture. The band saw blade member is locked into the jaws of one side of the welding fixture and the oscillating power tool blade shank is locked into the opposite side of the welding fixture. The butt welding tool is calibrated to ideal heat and feed rate for the blade shank to the band saw blade welding purposes. The leading edge of the oscillating power tool blade shank is welded to the trailing edge of the band saw blade member. The band saw blade member is trimmed on its left and right ends to form a smooth transition oscillating tool blade shank.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of saw blade reconditioning and more specifically to a method of reconditioning an oscillating power saw blade.

Saw blades of all types eventually become dull with extended use. It is a common practice to sharpen to recondition dull blades by using well known blade sharpening techniques.

One recent addition to the saw blade family is an oscillating saw blade that is used on recently developed oscillating power tools. The saw blade consists of a shank portion that attaches to the power tool, and the blade portion that is at the end of and perpendicular to the shank. These blades prove to be very difficult to sharpen due to the unique and varied size and shape of each different blade and shank.

Therefore these blades are traditionally disposed of after they become dull. Some commercial users of these blades dispose of hundreds of dull blades each month thereby incurring the high cost of replacement.

### BRIEF SUMMARY OF THE INVENTION

The primary object of the invention is to provide a method for reconditioning saw blades used in oscillating power tools.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a saw blade reconditioning method comprising: a band saw blade member made from a portion of band saw blade material, a standard oscillating power tool blade shank having the serrated blade portion removed, a novel butt welding fixture, said band saw blade member locked into the jaws of one side of said butt welding fixture, said oscillating power tool blade shank locked into the jaws of the opposite side of said welding fixture, said butt welding tool calibrated to ideal heat rate and feed rate of jaws for butt welding said tool blade shank to said band saw blade, the leading edge of said oscillating power tool blade shank member welded to the trailing edge of said band saw blade member, said band saw blade member trimmed on its left and right ends so that the said trailing edge of said band saw blade member is a similar length to the said leading of said oscillating tool blade shank, and the weld line of said weld sanded on a radial sanding belt so that removal of excess metal provides blade clearance.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of a typical oscillating power saw blade.

FIG. 2 is an exploded plan view of a length of band saw blade ready to be welded to the shank of an oscillation power saw blade.

FIG. 3 is a perspective view of a butt welding fixture with the band saw blade member and the oscillating power saw blade shank locked in place and ready for welding.

FIG. 4 is a perspective view of the weld being sanded.

FIG. 5 is a plan view of the reconditioned saw blade.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

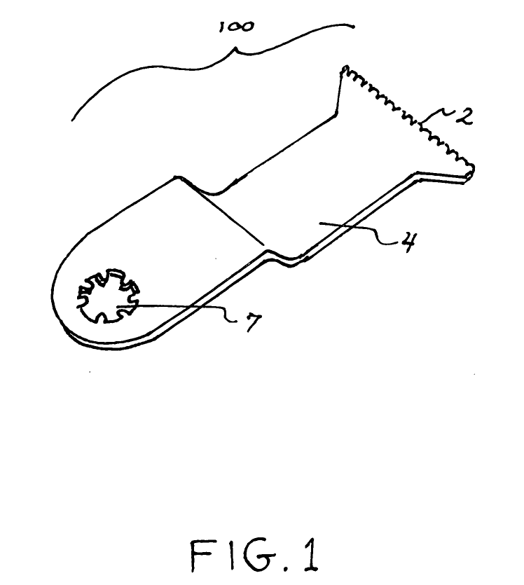

Referring now to FIG. 1 we see a perspective view of a standard saw blade 100 used in conjunction with a standard oscillating power tool, which has become a popular and versatile tool used in a variety of home and residential construction projects. The saw blade consists of a serrated toothed cutting edge 2 and a main body or shank portion 4. The shank portion 4 includes an aperture 7 that allows it to attach to the oscillating power tool, not shown. When this type of saw blade 100 becomes dull, it is very difficult to recondition because of the varying size an shape of the shank portion 4 and as a result, are typically thrown out. The user then has to purchase a new blade at a cost of fifteen to twenty dollars. The present invention is includes a method for reconditioning these saw blades 100 at a cost of approximately five dollars.

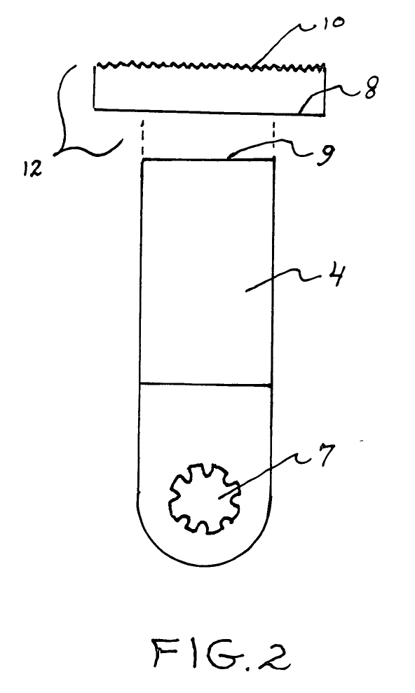

To recondition the blade 100, the serrated tooth end 2 of the blade is removed by standard cutting techniques. The shank 4 with the blade removed can be seen in the plan view of FIG. 2. A length of band saw blade material 12 can be seen in FIG. 2 before it is butt welded to the shank 4. The trailing edge 8 of the saw blade 12 will be butt welded to the leading edge 9 or the shank portion 4. The thickness of the blade 12 should be similar to the thickness of the shank 4.

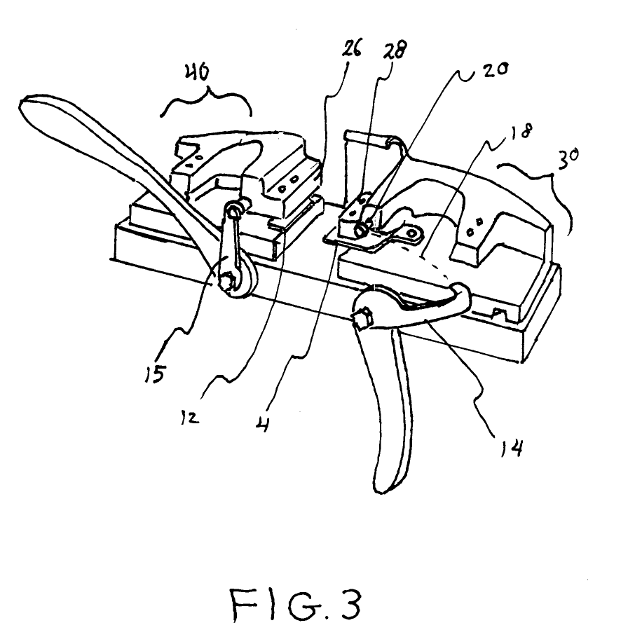

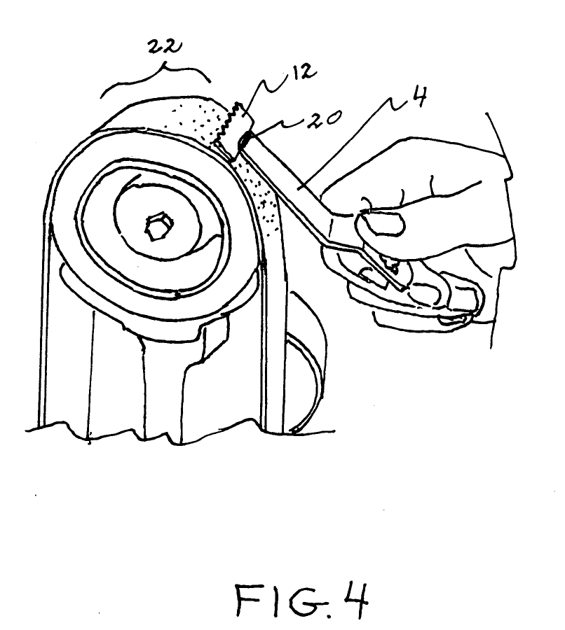

FIG. 3 shows a perspective view of a butt welder with specialized jaws 26, 28 that hold the band saw blade portion 12 on one side and the shank portion 4 on the other side. The jaws are locked in place by swing arms 14, 15. Arm 15 is already in place. Arm 14 is about to be swung into place as shown by dotted line 18. The right side of the welding fixture 30 is designed to slide toward the right side 40 of the welding apparatus until the trailing edge of the saw blade 12 and the leading edge of the shank 4 touch, and then continue to move forward slightly as the butt weld takes place. The heating functions and sliding travel functions of the butt welder must be set optimally to produce a perfect weld. The right jaw 28 is uniquely designed to accommodate the bent shape of the shank 4. FIG. 4 shows a perspective view of a person sanding the weld portion 20 of the reconditioned saw blade comprised of original shank 4 and new band saw blade length 12. The sanding procedure cleans up the weld and also removes a small amount of metal from each side of the blade which provides clearance under the teeth which reduces the chance of binding during the cutting process.

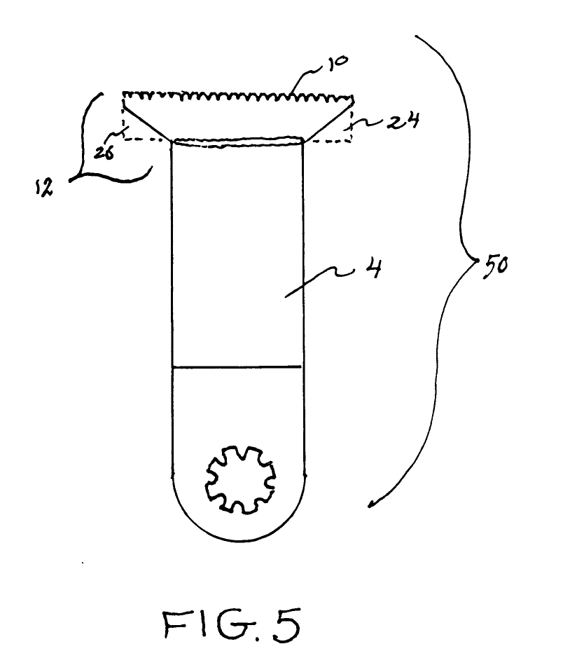

FIG. 5 shows the reconditioned oscillating saw blade 50. the corners 24, 26, shown in dotted lines, of each end of the band saw blade 12 have been trimmed so that the width of the trailing edge of the blade 12 matches the width of the leading edge of shank portion 4.

The reconditioned oscillating power saw blade can now be re-used in conjunction with a standard oscillating power tool. The oscillating blade 50 can be reconditioned to work as well as or better than the original blade that it has replaced because top quality band saw blade material can be used in the reconstruction process. These higher quality blades can last three to four times longer than the original serrated tooth edge 2. The reconditioned blades 12 tend to generate less friction and heat in comparison to the original serrated blade edge 2. Additionally, the original shank can be reconditioned with an alternate band saw blade member having a differing serration design depending on the intended final use of the blade. In this way, the new blade 12 can have a tooth design to cut plastic, or wood or metal. The new oscillating blade 50 can also be made of different qualities of steel ranging from carbon steel to high-speed steel. Even band saw blades having carbide grit or diamond grit, instead of teeth, can be butt welded to the shank 4 for cutting especially hard items such as ceramic tile.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. saw blade repair method comprising:
a band saw blade member made from a portion of band saw blade material;
a standard oscillating power tool blade shank having the serrated toothed blade portion removed;
a butt welding fixture;
said band saw blade member locked into the jaws of one side of said butt welding fixture;
said oscillating power tool blade shank locked into the jaws of the opposite side of said welding fixture;
said butt welding tool calibrated to ideal heat rate and feed rate of jaws for said tool blade shank to said band saw blade welding purposes;
the leading edge of said oscillating power tool blade shank member welded to the trailing edge of said band saw blade member;
said band saw blade member trimmed on its left and right ends so that the said the width of the trailing edge of said band saw blade member is similar to the width of the said leading edge of said oscillating tool blade shank; and
the weld line of said weld sanded on a radial sanding belt causing removal of excess metal providing better blade clearance.
